(19) United States
(12) Patent Application Publication
(10) Pub. No.: US 2014/0080435 A1
(43) Pub. Date: Mar. 20, 2014

(54) AUTOMATIC GAIN CONTROL ALGORITHM FOR RECEIVER ARCHITECTURE

(71) Applicant: Hughes Network Systems, LLC, Germantown, MD (US)

(72) Inventors: Maruf MOHAMMAD, Gaithersburg, MD (US); John Youssef, Frederick, MD (US); Brandon Lasher, Frederick, MD (US)

(73) Assignee: Hughes Network Systems, LLC, Germantown, MD (US)

(21) Appl. No.: 13/764,826

(22) Filed: Feb. 12, 2013

Related U.S. Application Data
(60) Provisional application No. 61/702,075, filed on Sep. 17, 2012.

(51) Int. Cl. H04W 52/52; H04B 1/16

(52) U.S. Cl. CPC H04W 52/52; H04B 1/16
USPC 455/234.2

(57) ABSTRACT

A logarithmic (LOG) based adaptive algorithm to track RF power received at a receiver is provided. The method includes: receiving, by a variable gain amplifier (VGA) having exponential gain characteristics, an input signal; and providing log-based gain control of the input signal by determining a power of the input signal, and generating, according to the determined power, a voltage control signal using a log-based function, wherein the VGA amplifies the input signal based on the voltage control signal.

### RELATED APPLICATION

This disclosure contains subject matter in common with provisional application 61/702,075, filed Sep. 17, 2012 by applicants Maruf Mohammad, John Youssef, and Brandon Lasher. The benefit of provisional application 61/702,075 is claimed under 35 U.S.C. §119(e).

### BACKGROUND

The present invention is generally drawn to receivers having Variable Gain Amplifiers (VGAs), for example in satellite communications. A VGA amplifies a received signal to allow further signal processing, for instance, analog-to-digital A/D conversion. VGAs are particularly important in satellite communication systems that must transmit signals vast distances from earth to satellites in orbit and vice-versa.

Suitable control of the VGA to track a radio frequency (RF) power received at the receiver is important for the operation of receivers, particularly for portable low power terminals. For example, some portable lower power terminals depend on a VGA to have a suitable gain applied to the signal before subsequent start-up processes. However, traditional means to control (e.g., algorithms) take a varying amount of time to find a suitable gain to track RF power received, causing inefficient timing.

What is needed is a control method (e.g., a LOG-based automatic gain control (AGC) algorithm) to track RF power received at a receiver that tracks RF power within a fixed amount of time, particularly a control method suitable to track RF power of satellite communicates received at a portable lower power terminal.

### SOME EXEMPLARY EMBODIMENTS

The present invention, according to certain embodiments, advantageously addresses the needs above, as well as other needs, by inter alia providing a logarithmic (LOG) based adaptive algorithm to track RF power received at a receiver, resulting in a fixed time-constant that is irrespective of the input RF signal strength.

According to an exemplary embodiment, a method includes: receiving, by a VGA having exponential gain characteristics, an input signal; and providing log-based gain control of the input signal by determining a power of the input signal, and generating, according to the determined power, a voltage control signal using a log-based function, wherein the VGA amplifies the input signal based on the voltage control signal.

Aspects include averaging the determined power over an integration period for the input signal, wherein the log-based gain control is based on the averaged power. Further aspects include: determining an error signal by comparing a reference power with the averaged power on a log scale; and filtering the error signal, wherein the log-based gain control of the input signal is based on the filtered error signal. Additional aspects include reducing the filtered error signal to a threshold value at a fixed time-constant for the log-based gain control irrespective of a strength of the input signal by the providing of the log-based gain control of the input signal. Some aspects include determining data of the input signal, after amplification by the VGA using the voltage control signal, by an analog-to-digital convert (A/D), wherein a detection error of the determined data is reduced to a threshold value by the fixed time-constant for the log-based gain control irrespective of the strength of the input signal by the providing of the log-based gain control of the input signal. Other aspects include a method, wherein a filtered error signal is reduced to the threshold value at the fixed time-constant for the gain control irrespective of a modulation scheme of the input signal. Further aspects include a method, wherein a lookup table is utilized to execute the log-based function.

According to another exemplary embodiment, an apparatus includes: at least one processor; and at least one memory including computer program code for one or more programs, the at least one memory and the computer program code configured to, with the at least one processor, cause the apparatus to perform at least the following, receive, by a VGA having exponential gain characteristics, an input signal, and provide log-based gain control of the input signal by, determining a power of the input signal and generating, according to the determined power, a voltage control signal using a log-based function, wherein the VGA amplifies the input signal based on the voltage control signal.

Additional aspects include, wherein the apparatus is further caused to average the determined power over an integration period for the input signal, wherein the log-based gain control is based on the averaged power. Further aspects include wherein the apparatus is further caused to: determine an error signal by comparing a reference power with the averaged power on a log scale; and filter the error signal, the log-based gain control of the input signal being based on the filtered error signal. Some aspects include wherein the apparatus is further caused to reduce the filtered error signal to a threshold value at a fixed time-constant for the log-based gain control irrespective of a strength of the input signal by the providing of the log-based gain control of the input signal. Further aspects include wherein the apparatus is further caused to determine data of the input signal, after amplification by the VGA using the voltage control signal, by an A/D converter, wherein a detection error of the determined data is reduced to a threshold value by the fixed time-constant for the log-based gain control irrespective of the strength of the input signal by the providing of the log-based gain control of the input signal. Additional aspects include the apparatus wherein a filtered error signal is reduced to the threshold value at the fixed time-constant for the gain control irrespective of a modulation scheme of the input signal. Some aspects include the apparatus wherein a lookup table is utilized to execute the log-based function.

According to yet another exemplary embodiment, an apparatus includes: a VGA, having exponential gain characteristics, configured to receive an input signal and to generate a corrected signal by adjusting a gain of the input signal using a control voltage; a signal detector configured to detect a power of the input signal; and an error detector configured to generate, according to the detected power, an error signal using a log scale, wherein the control voltage is derived from the error signal.

Some aspects include the apparatus, wherein a control voltage is derived based on a log-based function, the log-based function being set to reduce the error signal to a threshold value at a fixed time-constant for the log-based function irrespective of a strength of the input signal. Additional aspects include the apparatus further having an integrator and dump module configured to average the detected power over an integration period for the input signal. Some aspects include the apparatus further having a loop filter configured to filter the error signal. Further aspects include the apparatus further having a sigma-delta converter coupled to the loop filter and configured to generate the control voltage signal in response to the filtered error signal. Some aspects include the apparatus, wherein the apparatus is part of a receiver configured to receive the input signal via satellite-based wireless communications.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B and 1C illustrate communications systems capable of employing a LOG based algorithm to track RF power, in accordance with exemplary embodiments;

FIG. 2 illustrates a wideband automatic gain control (WAGC) system employing a LOG based algorithm to track RF power, in accordance with an exemplary embodiment;

FIG. 3 illustrates a WAGC system employing a LOG based algorithm to track RF power, in accordance with an exemplary embodiment;

FIG. 4 illustrates a flowchart of a method employing a LOG based algorithm to track RF power, in accordance with an exemplary embodiment;

FIG. 5 illustrates a VGA characteristic, in accordance with an exemplary embodiment;

FIGS. 6A and 6B illustrate compared time constant rates for a plurality of implementations, in accordance with an exemplary embodiment;

FIG. 7 illustrates a computer system upon which exemplary embodiments according to the present invention can be implemented; and

FIG. 8 is a diagram of a chip set that can be utilized in implementing a LOG based algorithm to track RF power, according to exemplary embodiments.

### DETAILED DESCRIPTION

A system, apparatus, and methods for a LOG based algorithm to track RF power, is described. In the following description, for the purposes of explanation, numerous specific details are set forth in order to provide a thorough understanding of the invention. It is apparent, however, that the invention may be practiced without these specific details or with an equivalent arrangement. In other instances, well known structures and devices are shown in block diagram form in order to avoid unnecessarily obscuring the invention.

In accordance with an exemplary embodiment, a shared bandwidth broadband communications system comprises a broadband satellite communications system, where multiple remote nodes (e.g., satellite terminals (STs)) access broadband services through one or more aggregation nodes (e.g., gateways (GWs) or IP gateways (IPGWs)). For instance, different STs subscribe to different services, whereby the STs associate with respective IPGWs that support the respective services of the terminal. An ST would dynamically select an IPGW from an eligible pool of IPGWs that support service configurations and subscriptions that satisfy the service requirements of the ST. The ST associates with the selected IPGW for provision of the required services to the terminal. Once the ST completes an association process, and the IPGW accepts the association, the terminal becomes associated with the selected IPGW. Once associated with an IPGW, an ST transmits and receives its communications service traffic (e.g., user data traffic) over the communications system via the associated IPGW.

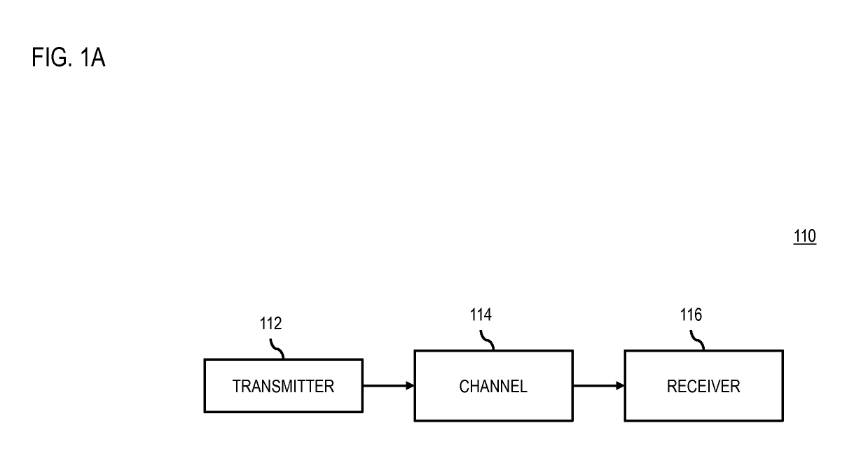

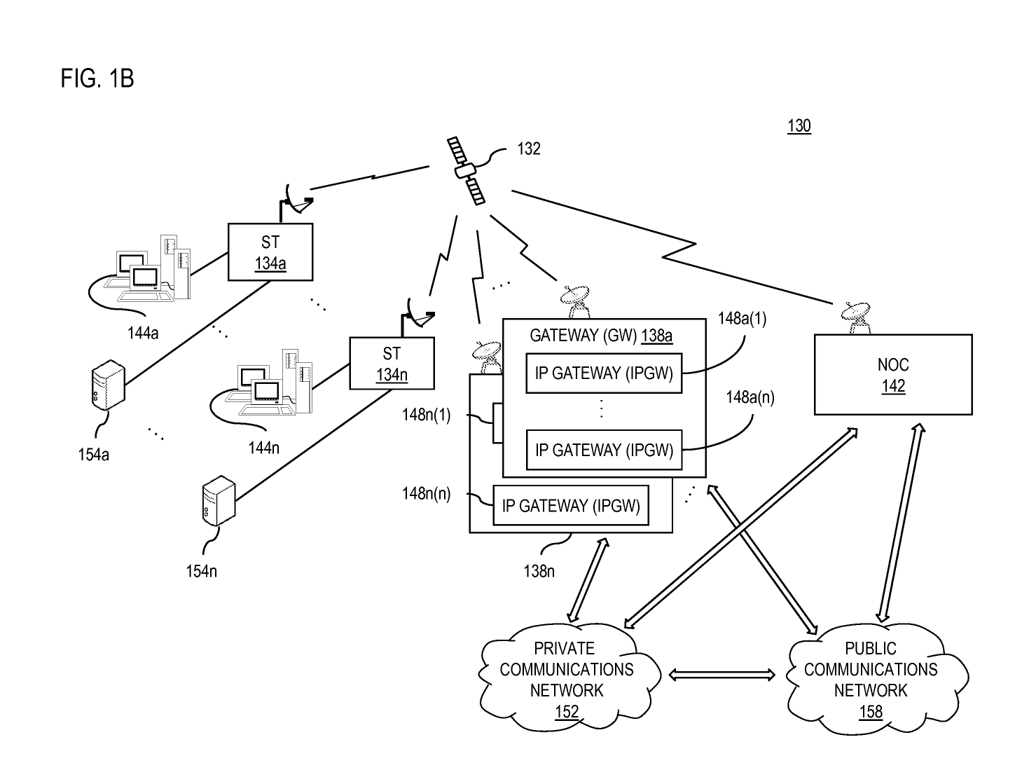

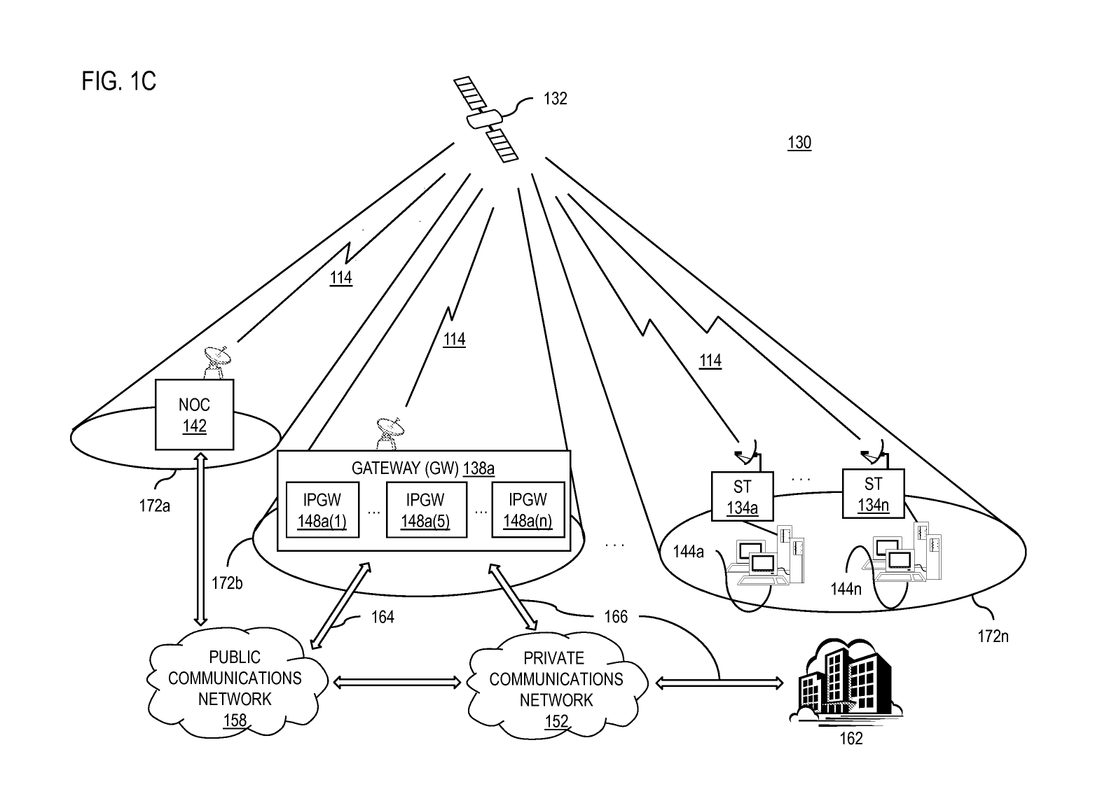

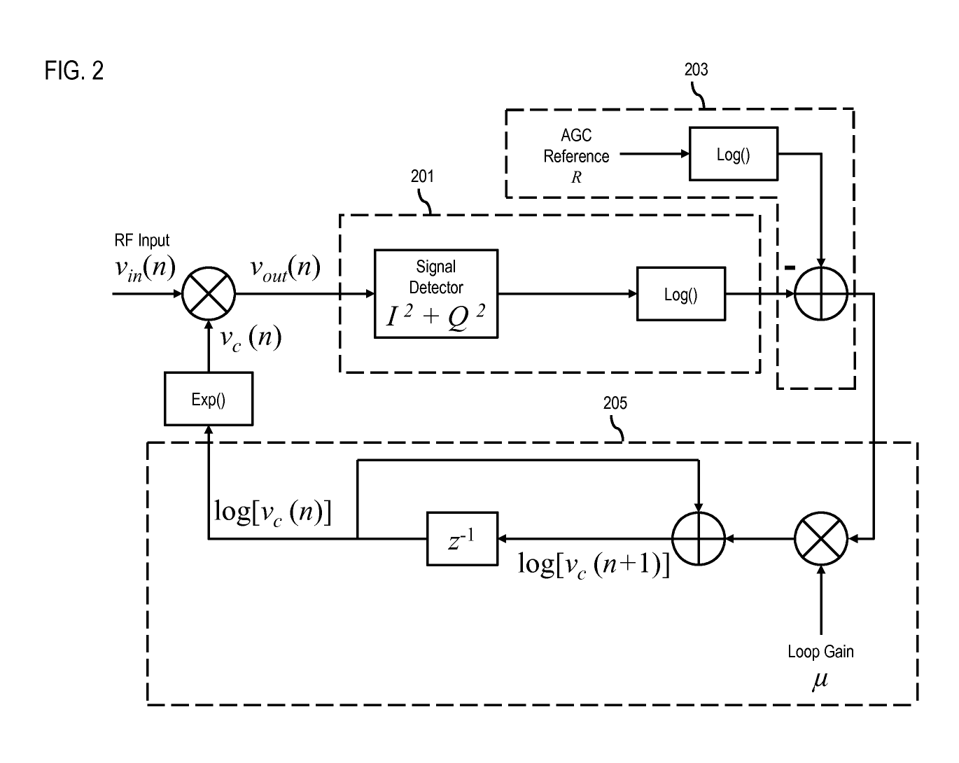

FIGS. 1A-1C illustrate communications systems capable of employing a LOG based algorithm to track RF power, according to various exemplary embodiments. With reference to FIG. 1A, a broadband communications system 110 includes one or more transmitters 112 (of which one is shown) that generate signal waveforms across a communications channel 114 to one or more receivers 116 (of which one is shown). The receivers 116, according to certain embodiments, utilize a LOG-based AGC algorithm that maintains fixed time-constant irrespective of the input RF signal strength. This feature ensures the AGC loop convergence in a pre-defined time enabling efficient timing and frequency correction loops are more fully detailed with respect to FIGS. 2-6. By way of example, receiver 116 can be in the front end of a digital video broadcasting—satellite—second generation (DVB)-S2 receiver. It is contemplated that such a receiver can be implemented in other applications.

In the discrete communications system 110, the transmitter 112 has a signal source that produces a discrete set of data signals, where each of the data signals has a corresponding signal waveform. These signal waveforms are attenuated, or otherwise altered, by communications channel 114. Coding may be utilized to combat noise and other issues associated with the channel 114, such as forward error correction (FEC) codes.

FIG. 1B illustrates an exemplary satellite communications system 130 capable of supporting communications among terminals with varied capabilities, according to exemplary embodiments. Satellite communications system 130 includes a satellite 132 that supports communications among multiple satellite terminals (STs) 134a-134n, a number of gateways (GWs) 138a-138n, and a network operations center (NOC) 142. The STs 134a-134n, according to certain embodiments, utilize a LOG-based AGC algorithm that maintains fixed time-constant irrespective of the input RF signal strength. According to different embodiments, the NOC 142 may reside at a separate site reachable via a separate satellite channel or may reside within a GW site. The NOC 142 performs the management plane functions of the system 130, while the GWs 138a-138n perform the data plane functions of the system 133. For example, the NOC 142 performs such functions as network management and configuration, software downloads (e.g., to the STs 134a-134n), status monitoring, statistics functions (e.g., collection, aggregation and reporting), security functions (e.g., key generation, management and distribution), ST registration and authentication, and GW diversity management. The NOC 142 communicates with each GW via the satellite 132, or via a secure private communications network 152 (e.g., an IPsec tunnel over a dedicated link or a virtual private network (VPN) or IPsec tunnel through a public network, such as the Internet). Additionally, each GW and the NOC have connectivity to one or more public communications networks, such as the Internet or a PSTN.

According to a further exemplary embodiment, each of the GWs 138a-138n include one or more IP gateways (IPGWs)—whereby the data plane functions are divided between a GW and its respective IPGWs. For example, GW 138a includes IPGWs 148a(1)-148a(n) and GW 138n includes IPGWs 148n(1)-148n(n). A GW may perform such functions as link layer and physical layer outroute coding and modulation (e.g., DVB-S2 adaptive coding and modulation), link layer and physical layer inroute handling (e.g., IPOS), inroute bandwidth allocation and load balancing, outroute prioritization, web acceleration and HTTP compression, flow control, encryption, redundancy switchovers, and traffic restriction policy enforcement. Whereas, the IPGW may perform such functions as data compression, TCP performance enhancements (e.g., TCP performance enhancing proxies, such as TCP spoofing), quality of service functions (e.g., classification, prioritization, differentiation, random early detection (RED), TCP/UDP flow control), bandwidth usage policing, dynamic load balancing, and routing. Further, a GW and respective IPGW may be collocated with the NOC 142. The STs 134a-134n provide connectivity to one or more hosts 144a-144n and/or routers 154a-154n, respectively. The satellite communications system 130 may operate as a bent-pipe system, where the satellite essentially operates as a repeater or bent pipe. Alternatively, the system 130 may employ a switching or processing satellite supporting mesh communications (point-to-point communications directly between, for example, the two STs 134a and 134n).

In a bent-pipe system of an exemplary embodiment, the satellite 132 operates as a repeater or bent pipe, and communications to and from the STs 134a-134n are transmitted over the satellite 132 to and from respective IPGWs associated with particular STs. Further, in a spot beam system, any one spot beam (e.g., beams 172a-172n) operates as a bent-pipe to geographic region covered by the beam. For example, each spot beam operates as a bent pipe communications channel to and from the STs and/or IPGW(s) within the geographic region covered by the beam. According to one embodiment, several GWs/IPGWs are distributed across the geographic region covered by all spot beams of the satellite 132, where, in a beam in which a GW (and respective IPGWs) are located, only the one GW (and no STs) occupies that beam. Further, each IPGW may serve as an aggregation node for a multitude of remote nodes or STs. The total number of GWs/IPGWs, and the geographic distribution of the GWs/IPGWs, depends on a number of factors, such as the total capacity of the satellite dedicated to data traffic, geographic traffic loading of the system (e.g., based on population densities and the geographic distribution of the STs), locations of available terrestrial data centers (e.g., terrestrial data trunks for access to public and private dedicated networks).

More specifically, with reference to FIG. 1C, for example, for a data communication from ST 134a to a public communications network 158 (e.g., the Internet), the ST 134a is associated with an IPGW (e.g., IPGW 148a(1)—selected from a pool of IPGWs available to the ST 134a, such as IPGWs 148a(1)-148a(5)—where the pool of IPGWs is a suitable subset of the IPGWs 148a(1)-148a(n) located at the GW 138a). The data is first transmitted, via the satellite 132, from the ST 134a to associated IPGW 148a(1). The IPGW 148a(1) determines the destination as being the Internet 158. The IPGW then repackages the data (e.g., as a TCP/IP communication), and routes the data communication, via the terrestrial link 164, to the Internet 158. Further, in a corporate network, for example, a corporation may deploy various remote STs at remote offices. More specifically, ST 134n, located at a remote corporate location, may desire to securely communicate with the corporate headquarters 162. Accordingly, for a data communication from ST 134n to the corporate headquarters 162, the data is first transmitted, via the satellite 132, from the ST 134n to an IPGW associated with the ST 134n (e.g., IPGW 148a(5)). The IPGW 148a(5) determines the destination as being the corporate headquarters 162. The IPGW then repackages the data (e.g., as an IPsec communication), and routes the IPsec data communication, via the secure terrestrial links 166 (over the private network 152), to the corporate headquarters 162. In the corporate network scenario, a further example involves a corporate communications from the corporate headquarters to a number of remote sites (e.g., a multicast communication to STs 134a-134n)—where STs 134a-134n are correspondingly associated with the two IPGWs 148a(1) and 148a(5) (e.g., grouped between the two IPGWs based on load balancing and IPGW capabilities). In this scenario, a gateway or router, within the local network of corporate headquarters 162, transmits the data communication, via the secure terrestrial links 166 (over the private network 152), to the IPGWs 148a(1) and 148a(5). The IPGWs determine that the communication is destined for the remote STs 134a-134n, and package the data as a multicast communication addressed to the community of STs 134a-134n. The IPGWs then transmit the data communication, via the satellite 132, for decoding by the community of STs 134a-134n. Accordingly, the satellite of such a system acts as a bent pipe or repeater, transmitting communications between the STs 134a-134n and their respective associated IPGWs 148a-148n.

FIG. 2 illustrates a WAGC system employing a LOG based algorithm to track RF power, in accordance with an exemplary embodiment. The WAGC system shown in FIG. 2 detects a signal level out of a baseband I/Q (in-phase/quadrature) imbalance compensator and generates a control voltage to drive an input RF signal at a desired power level. Some embodiments omit the I/Q compensator and detect a signal level of an input signal (not shown).

As illustrated in FIG. 2, the WAGC system includes a signal detector 201, error detector 203, and a loop filter 205. Signal detector 201 receives a signal, for instance, an output from a VGA, and detects a power of I/Q signals associated with the received signal. Error detector 203 determines a sample of the error in power level of the received signal by subtracting the detected power of the I/Q signals output by the signal detector 201 from a given reference. The loop filter 205 then generates a control voltage to control a VGA to track RF power by filtering out the error sample generated by the error detector 203 and converting the filtered sample into a form suitable to drive the VGA.

As noted above, traditional processes tracking RF input power require a varying amount of time to find a suitable gain (e.g., time-constant) for varying signal levels. For example, traditional methods typically have a time-constant for very low signal levels (e.g., RF input power levels) that is much higher compared to very high signal levels. However, typical VGAs at the RF front end of receivers have an exponential function to adjust the gain of the received signal.

It is noted a natural LOG-based error detector (e.g., 203) complements the exponential VGA and lends the loop linear in log-scale. A LOG based algorithm ensures symmetric time-constants for both high and low signal levels input into VGA 311 (e.g., RF input). Additionally, such a LOG based algorithm enables frequency correction loops. Another advantage of such a LOG based algorithm, as demonstrated in FIG. 2, is that it may be implemented in receiver chips supporting DVB-S2 and DVB-S2 Extended standards, and in future satellite-based wireless communications products. Further, a LOG based algorithm may utilize a power measurement instead of a voltage measurement to avoid level variations between modulation types. This is particularly important for modulations with multiple constellation rings, for example, a 32-APSK modulation scheme.

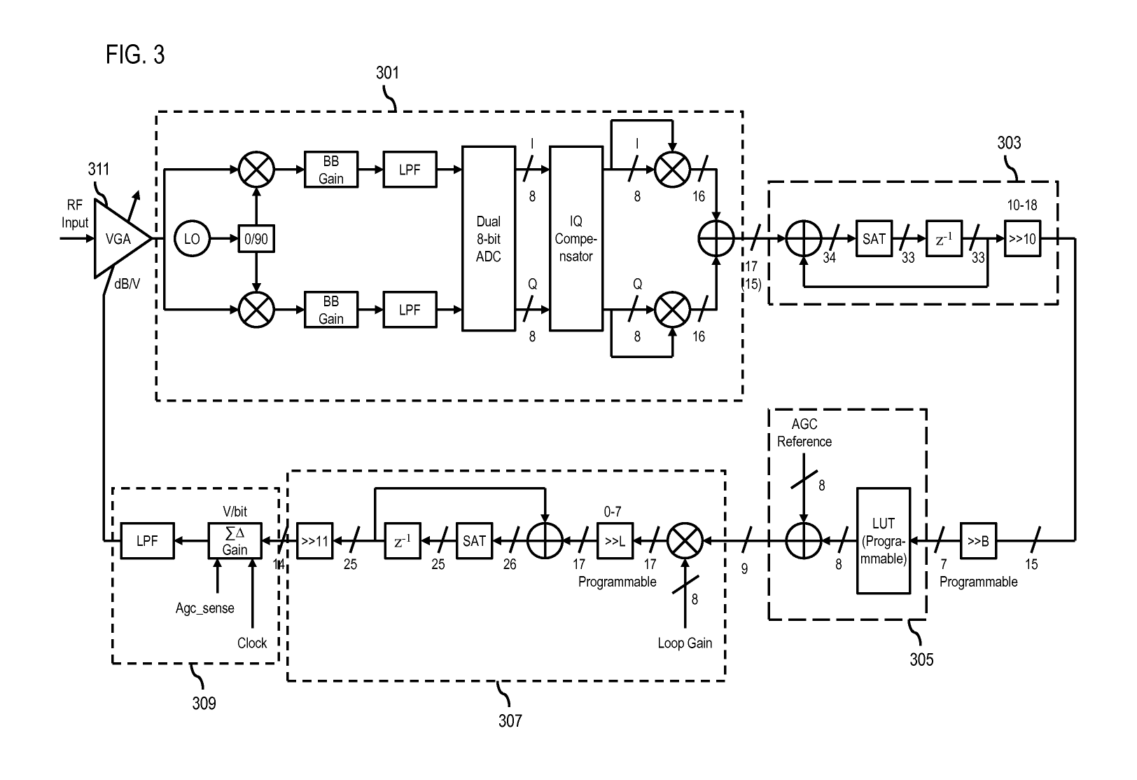

Adverting to FIG. 3, the WAGC system includes a signal detector 301, integrator and dump module 303, error detector 305, loop filter 307, sigma-delta convertor (D/A) 309, and VGA 311.

In operation, the signal detector 301 detects an I/Q power of an analog RF signal amplified by the VGA 311. For example, the analog RF signal is filtered (e.g., low pass filter) and fed into an 8-bit A/D converter. Additionally, for a full scale (8-bit) A/D loading, a voltage of 1 volt (peak-to-peak) is used at the input of the A/D. The loading of the A/D may be set by a reference level and can be limited by a saturation and clipping of the analog RF signal. In the exemplary embodiment, the signal detector 301 passes the I/Q signals coming out of the 8-bit A/D through an I/Q compensator to remove any DC bias caused by the 8-bit A/D and phase and amplitude offsets introduced by a tuner. The I/Q compensator may be omitted. The signal detector 301 determines a power from the compensated (or uncompensated) I/Q signal.

The integrator and dump module 303 averages power, for instance, the power detected by signal detector 301, over an integration period to smooth out variations. Such variations may be due to, for example, a pulse shaping filter. The integration period may be symbol rate dependent in order to average a sufficient number of symbols for any given symbol rate. Additionally, the integrator and dump module 303 may dump accumulated samples at the end of the integration period, for instance, by resetting the accumulator to zero.

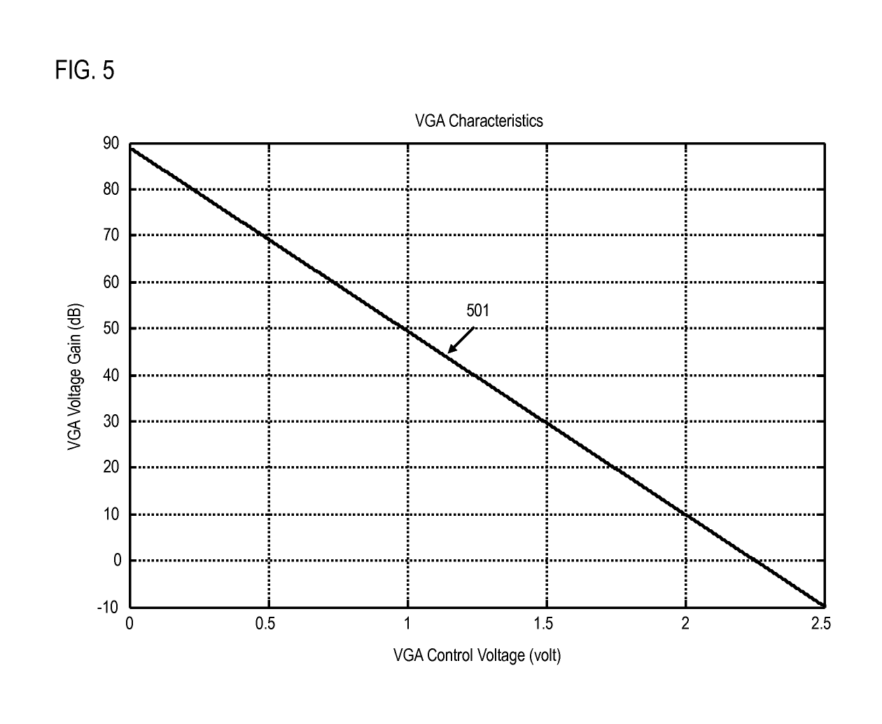

The error detector 305 computes the error between a reference power and an averaged power (e.g., Pin) of the incoming signal on a log scale. The loop filter 307 filters the error signal generated from the error detection unit. In one embodiment, the loop filter 307 determines a loop gain using a log conversion table and a received error to create a fixed-time constant. As shown, the feedback loop is negative to work with a VGA with negative-slope characteristic, for instance the VGA characteristics shown in FIG. 5. Additionally, loop filter 307 may shift the filtered output. For example, the output of the filter is right-shifted by 11-bit to feed to a 14-bit sigma-delta converter (e.g., D/A 309).

D/A 309 converts a digital output into a voltage signal configured to control VGA 311. As shown in FIG. 3, there is a first-order R-C filter which acts as a low-pass filter. For example, the bandwidth of the illustrated R-C filter is 130 Hz. In one embodiment, the WAGC is configured to enable a lower bandwidth of the loop without affecting the dynamics of the loop. The output of the R-C filter (and the D/A 309), called ‘control voltage’, is used to drive the VGA 311.

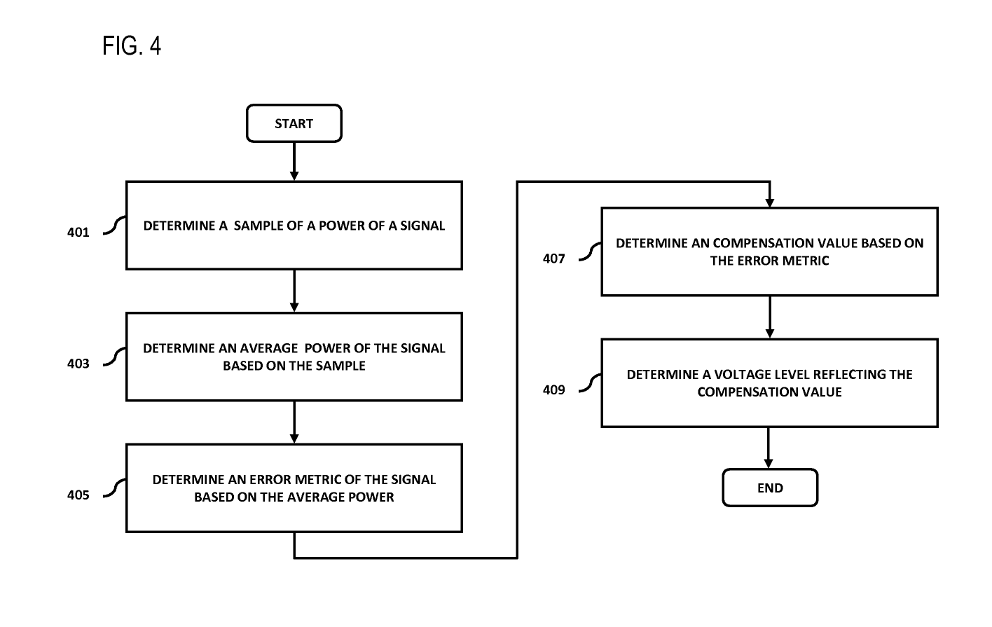

FIG. 4 illustrates a flowchart of a method employing a LOG based algorithm to track RF power, in accordance with an exemplary embodiment. Initially, a signal detector (e.g., 301), determines, as in step 401, a power of an input signal (e.g., an output of VGA 311).

The power of a signal detected by the signal detector 301 is formed as:

Pᵢₙ=I²+Q²

The integrator and dump module 303 then determines, as in step 403, an average power of the signal. In one embodiment, the integrator and dump module 303 collects L-number of samples of power received from the signal detector 301 and determines an average power based on the received samples. The average power is given by:

$${\overline{P}}_{in} = \frac{{\sum }_{i = 1}^{L} {P}_{in}^{i}}{L}$$

where: L=2^{int}^{_{—}}^{dump}^{_{—}}^{shift} is the integration period in samples and int_dump_shift is the right-shift after the integrator. As such, while signal detector 301 and the integrator and dump module 303 operate at a sampling frequency Fₛ, the rest of the loop (e.g., error detector 305, loop filter 307, D/A 309) is updated at

$$\frac{{F}_{s}}{L} .$$

In one embodiment, an 8-bit output is used from the integrator and dump module 303 even though the integrator and dump module 303 itself is 7-bit to enable the natural logarithm of an input value of zero to be set to the negative of the maximum value represented in 7-bits which is −128.

Next, the error detector 305 determines, as in step 405, an error metric of the signal based on the average power. For example, the error detector 305 determines an error metric based on a comparison of a reference power value with the average power determined by integrator and dump module 303. For example, the error detector calculates the error according to:

e(n)=Ref−log( P̅ᵢₙ)

where Ref denotes the reference level and is calculated as:

$$Ref = ⌊ log ( [ \frac{{I}_{ref}^{2} + {Q}_{ref}^{2}}{{2}^{LUT\_shift}} ] ) \cdot LUT\_gain ⌋$$

where I_{ref}, Q_{ref} denote the reference level of I and Q signals, respectively, while LUT_shift is the shift required to accommodate the LUT size and is given by:

LUT_shift=15−LUT_size

The scaling in the LUT is given by LUT_gain which is:

$$LUT\_gain = \frac{{2}^{LUT\_size} - 1}{log ( {2}^{LUT\_zize} - 1 )}$$

For example, an 6-bit A/D loading, I_{ref}=32, Q_{ref}=32, and if LUT_size=7 the reference is given by:

$$\begin{matrix}Ref = [ log ( [ \frac{{32}^{2} + {32}^{2}}{{2}^{8}} ] ) \cdot \frac{{2}^{7} - 1}{log ( {2}^{7} - 1 )} ] \\ = 55\end{matrix}$$

The loop filter 307 then determines, as in step 407, a compensation value based on the error metric value. For example, a digital loop filter may be used to, for instance, further reduce noise in the detected signal.

In one embodiment, the loop filter is a first order loop, defined as:

a(n+1)=a(n)−μe(n)

where a(n) is the loop filter accumulator value and μ is the loop gain.

As such, the loop is unconditionally stable for μ<1 and is independent of the input signal level. Combining this shift with loop gain the effective filter gain for the loop is given by:

$$filter\_gain = \frac{loop\_gain}{{2}^{11}}$$

In the exemplary embodiment, the initial value of the accumulator is set to 1.8811e+007 to ensure minimum error due to saturation and fixed point implementation at both ends of the supported signal range.

Next, the D/A 309 determines, as in step 409, a voltage level reflecting the compensation value. In one embodiment, the D/A 309 converts a digital value representing the compensation value determined by the loop filter 307 to a voltage representing the compensation value. For example, the D/A 309 produces a voltage of 3.3 volt for a 14-bit input signal by:

$${ΣΔ}_{gain} = \frac{3.3}{{2}^{14}}$$

FIG. 5 illustrates a VGA characteristic, in accordance with an exemplary embodiment. As shown, the VGA characteristic 501 has a negative-slope characteristic. Using an exemplary embodiment, for example, the WAGC system illustrated in FIG. 3, a VGA (e.g., 311) applies a voltage gain to the input signal depending on the control voltage.

The VGA voltage gain is calculated as:

G_{vga}=K₁e^{-K}^{₂}^{V}^{_{c}}

where K₁ and K₂ are constants derived from the VGA characteristic representing the offset and the slope, respectively, and V_{c} denotes the control voltage. The constants, in the exemplary embodiment, are found as K₁=28466, K₂=4.55. With the initial value of the loop filter accumulator set to 1.8811e+007, the initial control voltage is 1.85 volts.

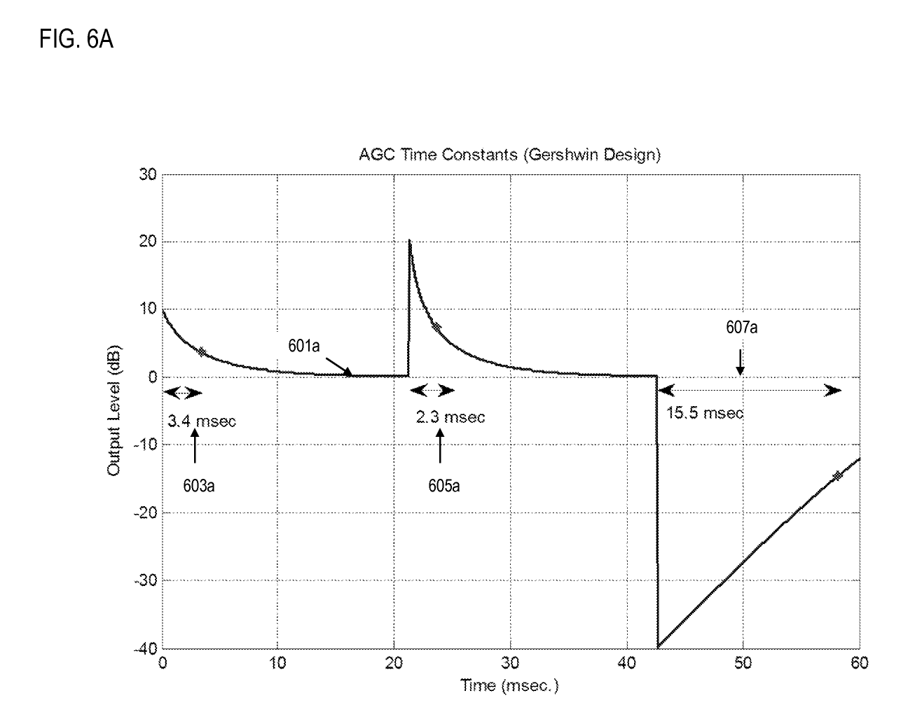

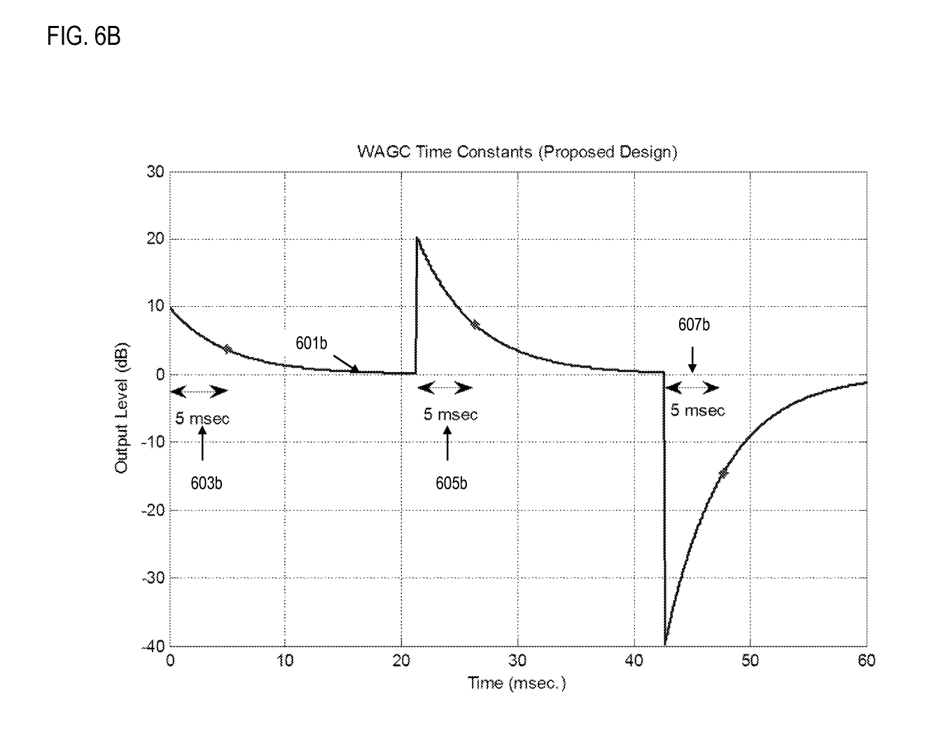

FIGS. 6A and 6B illustrate compared time constant rates for a plurality of implementations, in accordance with an exemplary embodiment. The loop response 601a illustrated in FIG. 6A shows results for a traditional method to track RF power in a WAGC design (used in Gershwin ASIC supporting DVB-S2 standard). The loop response 601b illustrated in FIG. 6B shows results for an exemplary embodiment of method employing a LOG based algorithm to track RF power in a WAGC design (e.g., adopted for SAHARA ASIC supporting DVB-S2 Extended standard).

The loop responses 601 show a power output level in db calculated based on a VGA voltage gain. Specifically, if Vᵢₙ denotes the input voltage, the VGA output voltage Vₒᵤₜ is given by:

Vₒᵤₜ=Vᵢₙ·G_{vga}

As noted above, the VGA voltage gain is calculated as:

G_{vga}=K₁e^{-K}^{₂}^{V}_{c}

where K₁ and K₂ are constants derived from the VGA characteristic representing the offset and the slope, respectively, and V_{c} denotes the control voltage.

Additionally, FIGS. 6A and 6B each show response times (e.g., time constants) for three difference RF power signal levels. The overall time-constant (sec.) of is given by:

$$τ = \frac{{2}^{int\_dump \_shift}}{2 \cdot LUT\_gain \cdot filter\_gain \cdot {ΣΛ}_{gain} \cdot {K}_{2} \cdot {F}_{s}}$$

The 3-dB bandwidth (Hz) is given by:

$${BW}_{3 dB} = \frac{1}{2 π τ}$$

As shown in FIG. 6A, the traditional loop response 601a has a first time constant 603a of 3.4 milliseconds (msec), a second time constant 605a of 2.3 msec, and a third time constant 607a of 15.5 msec. However, the loop response 601b has a first time constant 603b, a second time constant 605b, and a third time constant 607b of 5 msec. As such, while traditional designs have variable time-constant (especially for −ve input signal levels), the exemplary embodiments maintain a fixed time-constant for all input signal power levels. Further, when a WAGC is at the front-end of the receiver, a fixed time-constant helps the subsequent loops in a receiver to settle down in a timely manner, resulting in an improved overall acquisition performance of the receiver.

The processes described herein for a LOG-based AGC algorithm may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

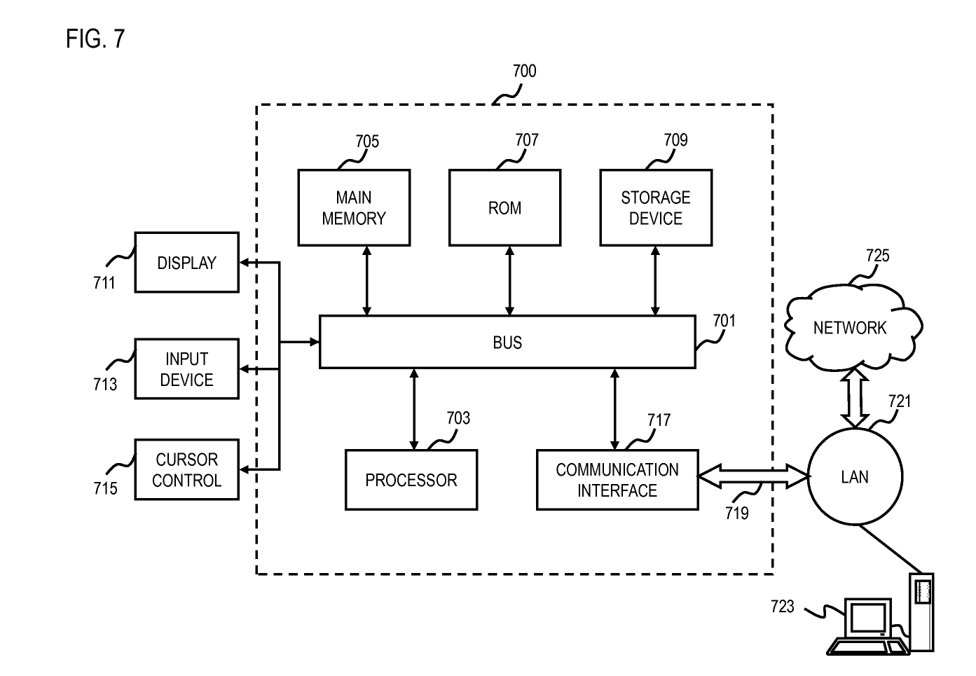

FIG. 7 illustrates a computer system upon which exemplary embodiments according to the present invention can be implemented. The computer system 700 includes a bus 701 or other communication mechanism for communicating information, and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions to be executed by the processor 703. The computer system 700 further includes a read only memory (ROM) 707 or other static storage device coupled to the bus 701 for storing static information and instructions for the processor 703. A storage device 709, such as a magnetic disk or optical disk, is additionally coupled to the bus 701 for storing information and instructions.

The computer system 700 is coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is cursor control 715, such as a mouse, a trackball, or cursor direction keys for communicating direction information and command selections to the processor 703 and for controlling cursor movement on the display 711.

According to one embodiment of the invention, dynamic and flexible architectures and methods for a LOG based algorithm to track RF power, in accordance with exemplary embodiments, are provided by the computer system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry is used in place of or in combination with software instructions to implement the embodiment of the present invention. Thus, embodiments of the present invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, or a telephone modem to provide a data communication connection to a corresponding type of telephone line. As another example, communication interface 717 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717, for example, includes peripheral interface devices, such as a Universal Serial Bus (USB) interface, a PCMCIA (Personal Computer Memory Card International Association) interface, etc.

The network link 719 typically provides data communication through one or more networks to other data devices. For example, the network link 719 provides a connection through local network 721 to a host computer 723, which has connectivity to a network 725 (e.g. a wide area network (WAN) or the global packet data communication network now commonly referred to as the “Internet”) or to data equipment operated by service provider. The local network 721 and network 725 both use electrical, electromagnetic, or optical signals to convey information and instructions. The signals through the various networks and the signals on network link 719 and through communication interface 717, which communicate digital data with computer system 700, are exemplary forms of carrier waves bearing the information and instructions.

The computer system 700 sends messages and receives data, including program code, through the network(s), network link 719, and communication interface 717. In the Internet example, a server (not shown) might transmit requested code belonging to an application program for implementing an embodiment of the present invention through the network 725, local network 721 and communication interface 717. The processor 703 executes the transmitted code while being received and/or store the code in storage device 709, or other non-volatile storage for later execution. In this manner, computer system 700 obtains application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as storage device 709. Volatile media may include dynamic memory, such as main memory 705. Transmission media may include coaxial cables, copper wire and fiber optics, including the wires that comprise bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD ROM, CDRW, DVD, any other optical medium, punch cards, paper tape, optical mark sheets, any other physical medium with patterns of holes or other optically recognizable indicia, a RAM, a PROM, and EPROM, a FLASH EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

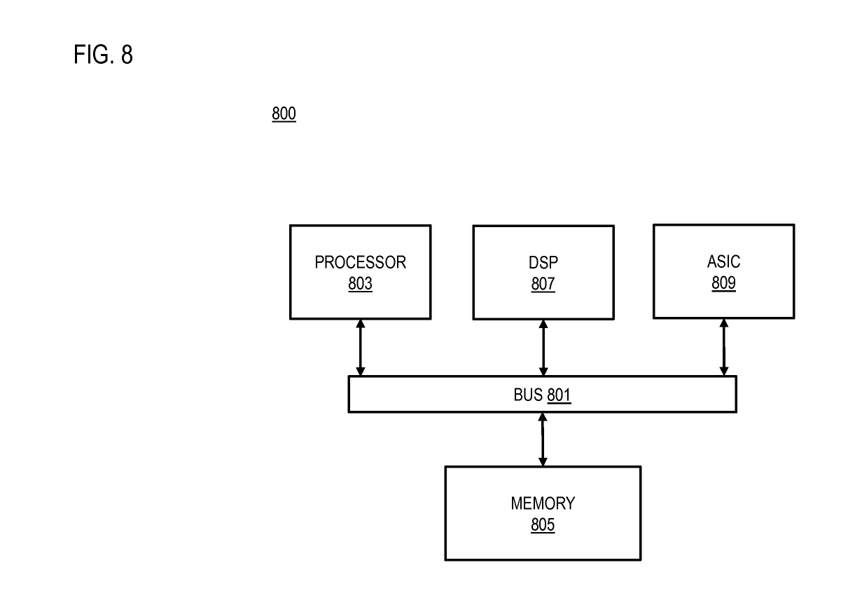

FIG. 8 illustrates a chip set 800 in which embodiments of the invention may be implemented. Chip set 800 includes, for instance, processor and memory components described with respect to FIG. 7 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 includes one or more processing cores with each core configured to perform independently. A multi-core processor enables multiprocessing within a single physical package. Examples of a multi-core processor include two, four, eight, or greater numbers of processing cores. Alternatively or in addition, the processor 803 includes one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, and/or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM) and static memory (e.g., ROM) for storing executable instructions that, when executed by the processor 803 and/or the DSP 807 and/or the ASIC 809, perform the process of exemplary embodiments as described herein. The memory 805 also stores the data associated with or generated by the execution of the process.

While exemplary embodiments of the present invention may provide for various implementations (e.g., including hardware, firmware and/or software components), and, unless stated otherwise, all functions are performed by a CPU or a processor executing computer executable program code stored in a non-transitory memory or computer-readable storage medium, the various components can be implemented in different configurations of hardware, firmware, software, and/or a combination thereof. Except as otherwise disclosed herein, the various components shown in outline or in block form in the figures are individually well known and their internal construction and operation are not critical either to the making or using of this invention or to a description of the best mode thereof.

In the preceding specification, various embodiments have been described with reference to the accompanying drawings. It will, however, be evident that various modifications may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by a variable gain amplifier (VGA) having exponential gain characteristics, an input signal; and
providing log-based gain control of the input signal by,
determining a power of the input signal, and
generating, according to the determined power, a voltage control signal using a log-based function, wherein the VGA amplifies the input signal based on the voltage control signal.

2. The method according to claim 1, comprising:
averaging the determined power over an integration period for the input signal, wherein the log-based gain control is based on the averaged power.

3. The method according to claim 2, comprising:
determining an error signal by comparing a reference power with the averaged power on a log scale; and
filtering the error signal, wherein the log-based gain control of the input signal is based on the filtered error signal.

4. The method according to claim 3, comprising:
reducing the filtered error signal to a threshold value at a fixed time-constant for the log-based gain control irrespective of a strength of the input signal according to the log-based gain control of the input signal.

5. The method according to claim 4, comprising:
determining data of the input signal, after amplification by the VGA using the voltage control signal, by an analog-to-digital (A/D) converter, wherein a detection error of the determined data is reduced to a threshold value by the fixed time-constant for the log-based gain control irrespective of the strength of the input signal according to the log-based gain control of the input signal.

6. The method according to claim 4, wherein the filtered error signal is reduced to the threshold value at the fixed time-constant for the gain control irrespective of a modulation scheme of the input signal.

7. The method according to claim 1, wherein a lookup table is utilized to execute the log-based function.

8. An apparatus comprising:
at least one processor; and
at least one memory including computer program code for one or more programs, the at least one memory and the computer program code configured to, with the at least one processor, cause the apparatus to perform at least the following,
receive, by a variable gain amplifier (VGA) having exponential gain characteristics, an input signal; and
provide log-based gain control of the input signal by,
determining a power of the input signal, and
generating, according to the determined power, a voltage control signal using a log-based function, wherein the VGA amplifies the input signal based on the voltage control signal.

9. The apparatus according to claim 8, wherein the apparatus is further caused to:
average the determined power over an integration period for the input signal, wherein the log-based gain control is based on the averaged power.

10. The apparatus according to claim 9, wherein the apparatus is further caused to:
determine an error signal by comparing a reference power with the averaged power on a log scale; and
filter the error signal, wherein the log-based gain control of the input signal is based on the filtered error signal.

11. The apparatus according to claim 10, wherein the apparatus is further caused to:
reduce the filtered error signal to a threshold value at a fixed time-constant for the log-based gain control irrespective of a strength of the input signal according to the log-based gain control of the input signal.

12. The apparatus according to claim 11, wherein the apparatus is further caused to:
determine data of the input signal, after amplification by the VGA using the voltage control signal, by an analog-to-digital (A/D) converter, wherein a detection error of the determined data is reduced to a threshold value by the fixed time-constant for the log-based gain control irrespective of the strength of the input signal according to the log-based gain control of the input signal.

13. The apparatus according to claim 11, wherein the filtered error signal is reduced to the threshold value at the fixed time-constant for the gain control irrespective of a modulation scheme of the input signal.

14. The apparatus according to claim 8, wherein a lookup table is utilized to execute the log-based function.

15. An apparatus comprising:
a variable gain amplifier (VGA), having exponential gain characteristics, configured to receive an input signal and to generate a corrected signal by adjusting a gain of the input signal using a control voltage;
a signal detector configured to detect a power of the input signal; and
an error detector configured to generate, according to the detected power, an error signal using a log scale, wherein the control voltage is derived from the error signal.

16. The apparatus according to claim 15, wherein the control voltage is derived based on a log-based function, the log-based function being set to reduce the error signal to a threshold value at a fixed time-constant for the log-based function irrespective of a strength of the input signal.

17. The apparatus according to claim 15, further comprising:
an integrator and dump module configured to average the detected power over an integration period for the input signal.

18. The apparatus according to claim 15, further comprising:
a loop filter configured to filter the error signal.

19. The apparatus according to claim 18, further comprising:
a sigma-delta converter coupled to the loop filter and configured to generate the control voltage signal in response to the filtered error signal.

20. The apparatus according to claim 15, wherein the apparatus is part of a receiver configured to receive the input signal via satellite-based wireless communications.
